(19) United States
(12) Patent Application Publication
(10) Pub. No.: US 2024/0352555 A1
(43) Pub. Date: Oct. 24, 2024

(54) METHOD FOR MELTING A CHARGE OF ALUMINIUM USING AN INDUCTION FURNACE

(71) Applicants: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(72) Inventors: Marc BERTHERAT, Veyras (CH); Anne PICHAT, Saint-Cassien (FR); Emmanuel WAZ, Chambery (FR); Alain VASSEL, Saint Etienne de Crossey (FR)

(73) Assignees: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(21) Appl. No.: 18/683,614

(22) PCT Filed: Aug. 29, 2022
(86) PCT No.: PCT/FR2022/051618

§ 371 Date: Feb. 14, 2024

(30) Foreign Application Priority Data
Aug. 31, 2021 (FR) FR2109082

(51) Int. Cl. C22B 21/00; C22B 7/00; C22B 9/00; F27B 14/06; F27B 14/08; F27D 3/00; F27D 11/06

(52) U.S. Cl. CPC C22B 21/0092; C22B 7/003; C22B 9/003; F27B 14/061; F27B 14/0806; F27D 3/0024; F27D 3/0025; F27D 11/06

(57) ABSTRACT

The invention relates to a method for melting an aluminum load, comprising: supplying an aluminum load (11, 12, 13) of which at least 15% by weight is in the form of a sow of essentially cylindrical shape (11) of height h and maximum diameter d; loading said load into a cylindrical induction furnace (10) of height H and maximum internal diameter D in which the height direction of said sow is substantially parallel to the height direction of the furnace; melting said load by induction to obtain a liquid metal bath (2); optionally adjusting content of said liquid metal in which d is in the range from 0.7 D to 0.97 D and preferably in the range from 0.84 D to 0.92 D.

### TECHNICAL FIELD

The invention relates to the melting of aluminum products and the manufacture of aluminum alloy intermediate products, such as especially rolling plates, extrusion billets or forging blocks, using an induction furnace.

### PRIOR ART

The carbon footprint of aluminum manufacturing is much lower when products are obtained by recycling existing raw materials than from primary aluminum obtained by electrolysis. It is therefore important to develop methods that allow the raw materials to be remelted economically and efficiently for recycling. In addition, induction furnaces for which melting is carried out electrically are favorable in terms of carbon emissions than gas furnaces, in particular when the electricity used is obtained without emissions.

However, the industrial efficiency of induction furnaces is often lower than that of gas ovens due to the lower melting rate, the limited size and the difficulty of loading the oven.

Patent EP1101830 describes a method for manufacturing an intermediate product, such as a plate, a billet or a forging block, of a given aluminum alloy of the series 7000, characterized in that it comprises:—a) providing products to be recycled such as scrap metal and machining scrap of at least one second alloy of the series 7000 having a target content, in at least one second anti-recrystallization element such as Zr or Cr, higher than the maximum acceptable content for the determined alloy; b) at least one step of refining the scrap metal and machining scrap, for reducing the content of this second anti-recrystallization element to a value below the maximum acceptable content in the determined alloy; c) fabricating a batch of liquid metal from the pure metal derived from the refining operation; d) forming the intermediate product (100) by casting (40) the liquid metal.

Patent EP1913166 describes a method for melting scrap of aluminum alloy containing lithium including (i) supplying scrap containing aluminum-lithium alloys (supply step); (ii) preparing an initial liquid metal bed of a first composition (liquid metal initial bed preparation step) in a melting furnace; (iii) loading said scrap onto said initial liquid metal bed so as to create on the surface of said liquid metal bed a floating mat of said scrap (loading step); (iv) melting said scrap mat so as to obtain a liquid metal bath of a second composition which may be identical to or different from the first composition (mat melting step); (v) taking the liquid metal (take step) from said liquid metal bath of a second composition.

U.S. Pat. No. 6,393,044 describes an induction melting system that uses a crucible formed by a material that has high electrical resistivity or high magnetic permeability and one or more induction coils formed from a wound cable consisting of several individually insulated copper conductors to form an induction furnace that, together with its power supply, offers a compact design.

Melting in induction furnaces is particularly useful for melting raw materials for recycling.

Types of raw materials for recycling aluminum and aluminum alloy (especially known as “scrap”) are described in EN 12258-3 standard.

In several industries, methods for manufacturing finished metal products by machining, transforming, cutting, etc. of intermediate products generate significant quantities of chips and machining scrap. Such surplus material is removed from intermediate products during manufacturing methods by turning, bar turning, planing, milling, facing, trimming, drilling, tapping, threading, sawing, reaming, or finish machining, or similar operations. This type of scrap concerns both small turn-type pieces, such as chips, and larger shredded scrap-type pieces, such as scrap from cutting or shearing thin or thick sheets, profiles, plates, billets.

Other types of scrap commonly used in recycling methods are used packaging such as used beverage cans and used food packaging.

The scrap may be in different forms such as prepared, bulk, crushed, granulated, compacted, clean, coated, anodized, kneaded forms, for direct melting.

Thus, in some cases, the scrap undergoes at least one first transformation to make it suitable for direct melting, such as compaction (in order to produce, for example, “bricks”) or melting (in order to produce remelting ingots such as “sows”). This first transformation can simplify transport, handling, melting and/or storage of scrap and chips and help improve scrap by reducing oil residues and obtaining a homogeneous composition.

A remelting ingot is thus a metal cast into a form suitable for remelting, possibly having undergone some metallurgical treatments aimed at rectifying the composition and/or removing some metal or non-metal impurities. A sow is a remelt ingot with a weight of typically 500 kg. A sow according to the invention is monolithic. By monolithic, it is meant that the sow consists of a single metal or alloy, which is inherent to the fact that it is a remelt ingot. Sows are usually in an overall parallelepiped shape and suitable for handling by forklift trucks. Sows are usually stored and used on demand for fabricating intermediate product, such as a rolling plate, extrusion billet, forging block.

The problem that the present invention seeks to solve is to improve productivity and energy efficiency of manufacturing method comprising melting in a cylindrical induction furnace, in particular for methods using a significant proportion of raw material for recycling.

### DISCLOSURE OF THE INVENTION

A first object of the invention is a method for melting an aluminum load, characterized in that it comprises:
supplying an aluminum load of which at least 15% by weight is in the form of a sow of essentially cylindrical shape with a height h and a maximum diameter d;
loading said load into a cylindrical induction furnace with a height H and maximum internal diameter D in which the height direction of said sow is substantially parallel to the height direction of the furnace;
melting said load by induction to obtain a liquid metal bath;
optionally adjusting the content of said liquid metal,
   where d is in the range from 0.7 D to 0.97 D.

A second object of the invention is a sow of essentially cylindrical shape made of aluminum with a height h and a maximum diameter d suitable for melting by the method according to the invention.

Another object of the invention is a method for manufacturing an intermediate product, such as a rolling plate, an extrusion billet, a forging block or an ingot or a sow characterized in that it comprises:
obtaining a liquid metal bath optionally content adjusted by the melting method according to the invention;
optionally filtering and/or treating said liquid metal (2);
forming said intermediate product (100, 101) by casting said liquid metal.

Still another object of the invention is a mold for casting a sow according to the invention.

### FIGURES

FIG. 1 illustrates a preferred embodiment of the method of the invention.

FIG. 2 illustrates a sow according to the invention.

FIG. 3a illustrates another sow according to the invention, and shows a top view and two cross-sectional views

FIG. 3b illustrates another sow according to the invention, and shows a perspective view.

FIG. 4 illustrates possible handling of sows according to the invention.

FIG. 5 illustrates a mold according to the invention.

FIG. 6a illustrates loading of the example, with parallelepiped blocks.

FIG. 6b illustrates loading with sows according to the invention.

FIG. 7 illustrates one embodiment of an intermediate product manufacturing method according to the invention.

FIG. 8 is a cross-sectional view of a sow according to one embodiment of the invention.

### DETAILED DESCRIPTION OF THE INVENTION

Unless otherwise specified, the definitions of EN12258 standard, in particular EN12258-1 and 12258-3, apply.

The applicant found that, contrary to expectations, the use of sows of essentially cylindrical shape with a dimension adapted to the furnace dimension makes it possible to significantly reduce the loading time and the melting time in a cylindrical induction furnace.

According to the invention, the method for melting an aluminum load comprises:
supplying an aluminum load;
loading the load in an induction furnace;
melting the load.

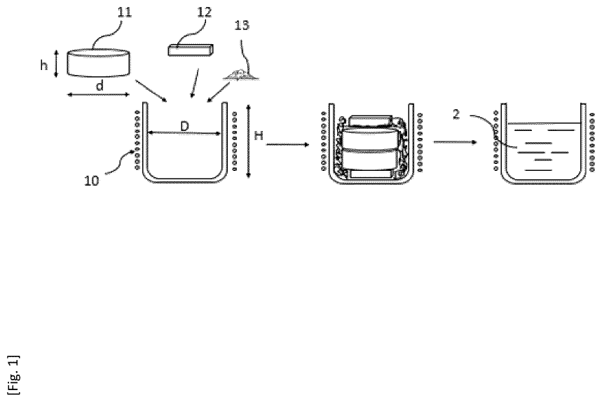

This method is illustrated in FIG. 1.

In the present invention, the term aluminum means pure aluminum as well as all aluminum alloys comprising at least 50% aluminum, such as in particular alloys described in Teal Sheets published by The Aluminum Association.

In the supply step, at least 15% by weight of the aluminum load is in the form of a sow of essentially cylindrical shape (11) with a height h and a maximum diameter d. Depending on the dimension of the sow, one sow may be sufficient to reach this minimum amount, but generally several, typically two, three, four or more sows are used. Preferably, at least 25%, preferentially at least 35% or even at least 50%, at least 70% or at least 90% by weight of the load is in the form of a sow of essentially cylindrical shape (11). According to the invention, the weight of the sow(s) of essentially cylindrical shape is at least 100 kg, preferably at least 300 kg, even more preferably at least 400 kg, advantageously at least 500 kg. In one embodiment of the invention, the weight of the sow(s) of essentially cylindrical shape is at least 700 kg advantageously at least 1000 kg and preferably at least 1500 kg. Sows of a weight of less than 700 kg, for example between 100 kg and 700 kg, may however be suitable alone or in combination with higher-weight sows.

The sow is essentially cylindrical in shape, that is its shape mainly consists of one or more cylinders and/or one or more truncated cones superimposed with a same axis of revolution, such that the maximum diameter and the minimum diameter of all the cylinders and/or truncated cones do not differ by more than 10%, preferably by more than 7% and preferably by more than 5%. Thus, a cross-section perpendicular to the axis of revolution of the essentially cylindrical shape is generally circular. Any cross-section perpendicular to the axis of revolution of the essentially cylindrical shape may consist of a partially truncated circle but the truncated part represents less than 50% of the circular perimeter and preferably less than 40%. The essentially cylindrical shape may have a central opening. The essentially cylindrical shape may include legs. The height h of the essentially cylindrical shape corresponds to the maximum dimension perpendicular to the maximum diameter, that is along the axis of revolution. Preferably, the sow is monolithic of aluminum alloy, essentially cylindrical in shape with a height h and a maximum diameter d wherein d is in the range of 0.7 D to 0.97 D where D is the maximum internal diameter of a cylindrical induction furnace.

To complete the load, aluminum is used in other forms such as in particular raw forms (12) of the type of ingot, billet, plate and transformed forms (13) at different manufacture steps such as strips, sheets, profiles, bars, tubes, wires, forged parts, that is production scrap, in particular shredded scrap from cutting, shearing or similar operations, or post-use products such as used drink cans, used packaging, incinerator scrap, turnings comprised of grains, chips, frisons, produced by machining, or other operations. When the scrap is coated, a stripping operation is advantageously performed to obtain stripped scrap. The scrap after use is preferably ground. In one embodiment of the invention, at least 15% and preferably at least 30% or even 40% by weight of the load is in the form of transformed products (13) preferably in very divided form such as shredded scrap, turnings, used beverage cans or used packaging.

The origin of aluminum in any form may be primary aluminum extracted from a metal compound by reduction, or by decomposition of a metal compound or remelt metal, that is metal that has already been solidified a first time. In one embodiment, the sow according to the invention is obtained by casting primary metal. In another embodiment, the sow according to the invention is obtained by casting remelt metal. Preferably, the sow according to the invention is obtained by casting remelt metal comprising recovery scrap from products after use. In one embodiment of the invention, at least 60% of the filler is derived from remelt metal, preferably production scrap or recovery scrap.

Preferably, the filler consists of suitably sorted alloys of the 2XXX or 3XXX or 4XXX or 5XXX or 6XXX or 7XXX or 8XXX series. In one advantageous embodiment, the filler consists of alloys of the 2XXX series containing at least 0.5 wt % lithium such as for example AA2050, AA2196 or AA2198 alloys. In another advantageous embodiment, the filler consists of alloys of the 3XXX series and contains at least 30% used beverage cans or used packaging.

The load is then loaded into a coreless crucible induction furnace of essentially cylindrical shape (10), hereinafter referred to as “cylindrical induction furnace”. The cylindrical induction furnace has a maximum internal diameter D, corresponding to the maximum internal diameter of the furnace crucible. The crucible can be removable or integral therewith. By essentially cylindrical shape, it is meant that its shape mainly consists of one or more cylinders and/or one or more superimposed truncated cones with a same axis of revolution, such that the maximum diameter and the minimum diameter of all the cylinders and/or truncated cones do not differ by more than 10%, preferably not more than 7% and preferably not more than 5%. The maximum diameter d of the sows according to the invention is adapted to the maximum internal diameter D of the furnace so d is in the range from 0.7 D to 0.97 D and preferably in the range from 0.84 D to 0.92 D. The precise adaptation of the maximum diameter of the sow according to the invention to the furnace and its essentially cylindrical shape allow, in particular, to generate a better inductive coupling with the coils of the induction furnace and also allows density of the load in the furnace to be increased. Furthermore, it is preferable that the height h of the sow be at most 50%, preferably at most 40% and preferably at most 30%, of the maximum diameter d to avoid metallurgical defects upon casting the sows.

The sow is loaded in such a way that the height direction of the sow is approximately parallel to the height direction of the furnace. Advantageously, loading the sows is performed in a single operation regardless of the number of sows loaded.

Advantageously, the sow of essentially cylindrical shape comprises an opening (111) in its center. The opening (111) especially allows insertion of a handling tool, for example, attached to the forklift truck or an overhead crane.

In one embodiment, loading the sow according to the invention is performed after tilting the furnace horizontally. The sow is tilted and loaded, for example, using a forklift truck. It is advantageous in this embodiment to use a sow whose circular perimeter has been truncated so as to ensure stability when tilted, its height h being then in the horizontal position. In this embodiment and when several sows are loaded, it is advantageous for the sows to be tilted and loaded, for example, using a handling tool attached to a forklift truck and inserted into the openings (111) in a single operation. It is advantageous in this embodiment to use identical sows whose circular perimeter has been truncated so as to ensure stability when tilted. The furnace is then tilted back vertically for the introduction of other load elements such as scrap.

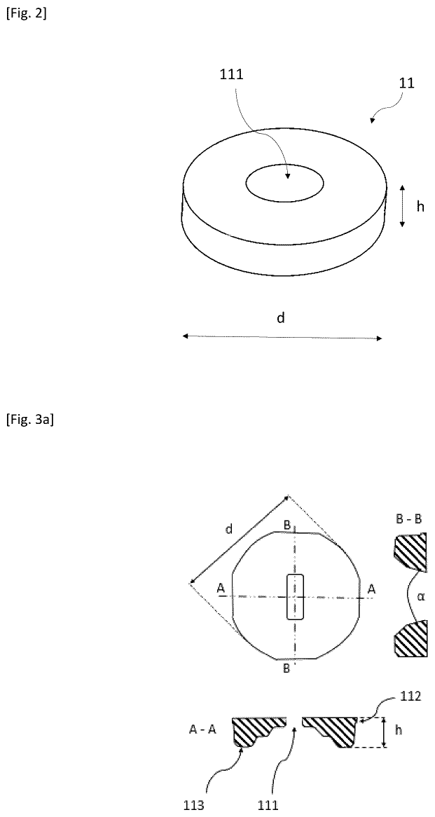

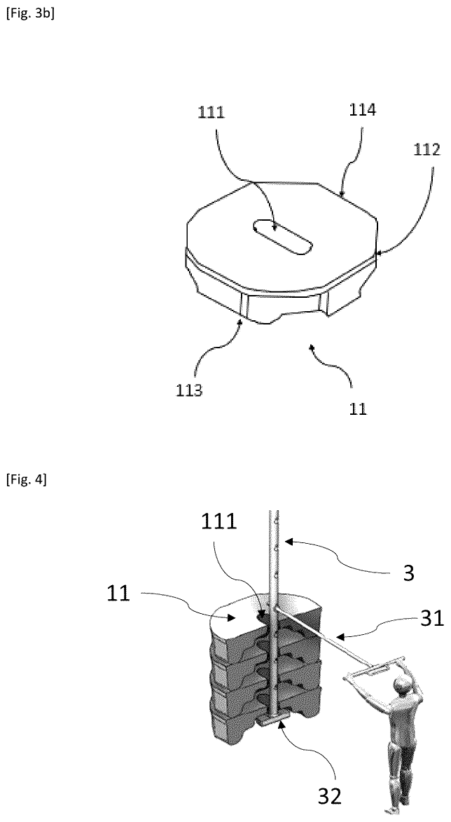

In another embodiment, the sow is introduced into the furnace in a vertical position. The sow may for example be handled using a suitable handling tool inserted into the opening (111) and inserted into the furnace without touching the walls of the induction furnace. If a circular opening as illustrated in FIG. 2 is made, possibly beveled, a pneumatic tool having an expandable mandrel can for example be used. An oblong opening as illustrated in FIG. 3 can also be made. As illustrated by FIG. 4, a handling tool (3) comprising a rectangular wedge (32) may be introduced into the oblong opening (111), and then pivoted using a rod (31) so as to be blocked under the sow. The assembly can then be easily handled using an overhead crane, the reverse operation being carried out to release the handling tool (3) when the sows are positioned in the furnace.

In both cases, it is possible to directly insert a stack of sows according to the invention, which makes the loading operation particularly fast, avoids degradation of refractories of the crucible and can be carried out by a single operator.

In one embodiment, the furnace is first partially filled with production scrap and/or recovery scrap (13) and/or ingots (12), then the sows according to the invention are introduced, then again production scrap and/or recovery scrap are introduced, in particular into the space remaining between the sows according to the invention and the walls of the furnace, the loading being finally completed with production scrap and/or recovery scrap and/or ingots. In another embodiment, sows according to the invention are first introduced, then production scrap and/or recovery scrap are introduced, especially into the space remaining between the sows according to the invention and the furnace walls, the loading being finally completed with production scrap and/or recovery scrap and/or ingots. It may be advantageous in one embodiment not to center the sows according to the invention in the furnace so as to facilitate introduction of production scrap and/or recovery scrap.

The present inventors have found that it is advantageous for melting to be faster and less energy-consuming that at least one sow according to the invention is positioned around the mid-height of the furnace. Thus, in one advantageous embodiment, the diameter positioned at mid-height h/2 of the sow of essentially cylindrical shape is located at a distance from the bottom of the furnace, that is from the bottom of the crucible, between H/2−H/4 and H/2+H/4 and preferably between H/2−H/5 and H/2+H/5.

Melting of the load is then performed by induction to obtain a liquid metal bath (2). Melting can be performed under an inert atmosphere or in ambient air, with or without a lid. The power and frequency used are selected according to the furnace used and the load. Typically, the power is 40% to 100% of the maximum power and the frequency is from 50 Hz to 400 Hz. The frequency is especially adapted to the dimension of the induction furnace.

It should be noted that in one embodiment, melting can be started before the complete introduction of the load: once the load has partially molten, it is possible in some cases to resume the loading cycle and, for example, to introduce scrap using pliers, a worm screw or by emptying a bucket.

Optionally; the alloy elements for content adjusting are then furnace charged to achieve the target composition. Alloy elements are generally added as high-alloyed aluminum alloys in a single element or containing these elements or as pure additive metals. The different forms used to add alloying elements are known as “MAFM” which means “master alloys and filler metals”.

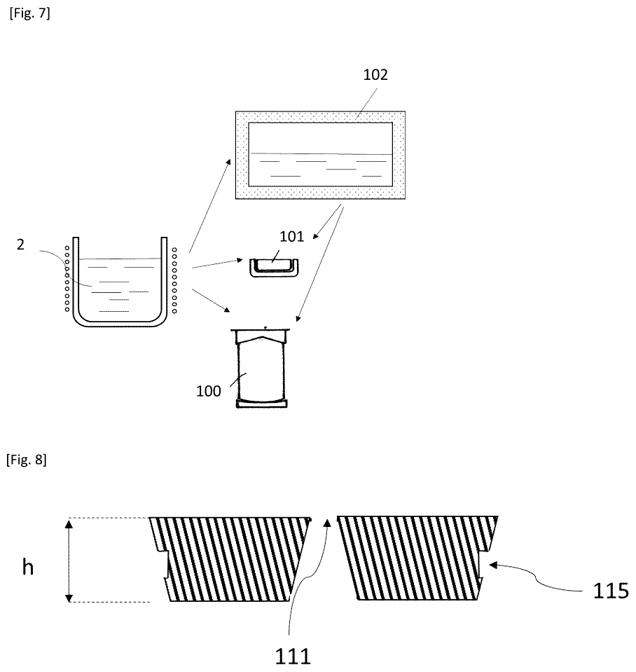

The invention also relates to a method for manufacturing an intermediate product (100, 101), such as a rolling plate, an extrusion billet, a forging block (100) or an ingot or sow (101), wherein a step of casting the liquid metal obtained by the melting method according to the invention is performed. This method is illustrated in FIG. 7.

Optionally, the cast metal may be transferred to a large-dimension furnace (102) in an intermediate manner, for example to gather the liquid metal derived from several induction furnaces.

Optionally, filtration and/or liquid metal treatment steps can be performed before casting. Typically, the liquid metal can be filtered on a filtering medium in a “filtration bag” or a so-called “treatment” gas which can be inert or reactive in a “degassing bag” can be introduced into the liquid metal bath. In one advantageous alternative to this embodiment, the method comprises gas treating the metal to remove inclusions. The gas preferably comprises approximately chlorine, the remainder being typically nitrogen or argon.

The liquid metal is then directed to a liquid metal solidification device (or “casting machine”), to form an intermediate product such as a rolling plate (100), a extrusion billet, a forging block, an ingot, or a sow (101).

The method can also be semi-continuous, with only a part of the liquid metal being taken for casting, a liquid heel remaining in the furnace, and solid aluminum being introduced into the liquid heel.

The invention also relates to a sow of essentially cylindrical shape of aluminum adapted for melting in a cylindrical induction furnace. Preferably, the weight of the sow essentially cylindrical shape is at least 700 kg and preferably at least 1000 kg or even at least 1500 kg. The sow is essentially cylindrical in shape as defined. Any cross-section perpendicular to the height of the essentially cylindrical shape may consist of a partially truncated circle but the truncated part represents less than 50% of the circular perimeter and preferably less than 40%. The essentially cylindrical shape may have a central opening. The essentially cylindrical shape may include legs. The height h of the essentially cylindrical shape corresponds to the maximum dimension perpendicular to the maximum diameter. Preferably, the sow according to the invention has an opening in its center (111). In one embodiment, the opening is circular as illustrated in FIG. 2, and possibly beveled. In another embodiment, the opening is oblong as illustrated in FIG. 3. Advantageously, the oblong opening is also beveled, as especially shown by the cross-section B-B of FIG. 3a in order especially to facilitate mold release of the sow. The bevel angle is chosen so as to optimize compromise between the mold release and the amount of metal, advantageously the bevel angle α is in the range from 15° to 50°, preferably in the range from 25° to 35°. In one embodiment, an oblong or circular shaped groove (114) allows the handling tool to vertically or horizontally pass therethrough with a clearance of at least 20 mm for expansion.

In order to facilitate the handling thereof, the sow can be provided with at least 2 legs (113). In one embodiment, the sow is provided with four legs. This makes it possible to handle the sow with a forklift truck in all directions and cut it in half without losing stability. The geometry of the sows especially allows secure stacking of 4 stable heights, advantageously 5 or 6 stable heights, in particular for sows comprising 4 legs having 4 bearing zones.

In another embodiment not including a leg and illustrated by FIG. 8 which represents a transverse cross-section of the sow, the sow is provided with two notches (115) for handling it.

Advantageously, the sow is provided with a collar (112). The function of the collar is to give a visual indication when filling the sow mold and when using the sow. The absence of a collar will alert operators to the lowest filling of the mold and, if necessary, to the lower strength of the sow. The collar also secures the minimum height for manipulating. The diameter at the collar can represent the maximum diameter.

In one embodiment, the sow of essentially cylindrical shape is truncated at the ends by at least one diameter (114). In one embodiment, the diameter is truncated at the ends by two perpendicular diameters.

The advantage of making a truncation of the diameter is, on the one hand, to allow vertical positioning on the slice of the sows and thus to facilitate introduction in the embodiment where the furnace is tilted or to facilitate horizontal positioning by positioning the sows against a frame at a 90° angle and thus facilitate the introduction of the manipulating system and its extraction once the sow is positioned in the furnace in the embodiment where the furnace is not tilted, and also to facilitate the introduction of scrap into the oven once the sow is positioned in the oven. However, it is important that the shape remains essentially cylindrical in order to maximize inductive coupling with the coils of the induction furnace.

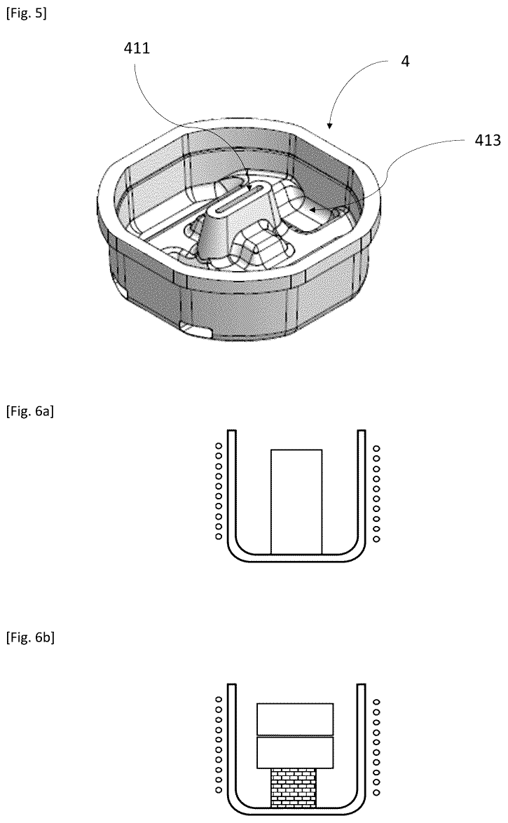

The invention also relates to a mold (4) for casting a sow according to the invention. An example of a mold according to the invention is illustrated by FIG. 5. The mold has a shape allowing easy mold release of the sows, in particular the relief angles are adjusted, for example by modeling using simulation tools known to those skilled in the art. Preferably, the mold according to the invention comprises pockets (413) for forming the legs and allowing bottom casting without turbulence, which has the effect of reducing formation of oxides. Advantageously, the mold comprises a central tip (411) for making the opening (111). In one advantageous embodiment, the central tip (411) for making the opening (111) is removable. Preferably, the central tip is recessed in order to improve cooling and avoid metallurgical defects such as porosities, gas cavities, shrinkage cavities and solidification cavities. Furthermore, it is preferable that the height h of the sow be at most 50%, preferably at most 40% and preferentially at most 30%, of the maximum diameter d to avoid metallurgical defects. Thus, preferably, the sow according to the invention is free of metallurgical defects such as porosities, gas cavities, shrinkage cavities and solidification cavities. The mold according to the invention is preferably made of cast iron, such as grey cast iron or spheroidal cast iron or cast steel.

The sow according to the invention has many advantages.

Firstly, it allows improvement of the inductive coupling in cylindrical crucible induction furnaces thanks in particular to the overall cylindrical shape which allows control of the distance to the wall. Thus, the melting time is reduced by at least 15% and preferably by at least 30%. In addition, the geometry allows improvement in fire waste of at least 0.5% and preferably at least 1%. The geometry used also improves the furnace filling rate by at least 15% and the loading time by at least 10%, thereby increasing method productivity. The sow geometry also avoids arching, which improves method safety. Since loading is facilitated, the risk of damage to the refractories are limited, which improves their service life.

The mold according to the invention is advantageous because it allows rapid mold release by turning over, accelerated solidification by maximizing heat exchanges and obtaining defect-free sows.

### Example

Melting tests of different loads have been carried out in a cylindrical induction furnace with a capacity of 500 kg and an internal diameter D of 500 mm. Melting of a parallelepiped block placed vertically in the center of the furnace has been compared with melting of cylindrical sows according to the invention with the same total mass 100 kg as the parallelepiped block, with a maximum diameter of 384 mm and placed at mid-height of the coil (FIG. 6). The reference block is also centered in relation to the mid-height of the coil. A frequency of 385 Hz has been used, the power used corresponded to 50% of the furnace nominal power.

The test shows a 37% reduction in the melting time of the sows placed at mid-height of the inductors (FIG. 6b) compared to the parallelepiped block placed vertically (FIG. 6a). These tests have moreover been used to set a melting model.

1. A method for melting an aluminum load, characterized in that it comprises:
supplying an aluminum load (11, 12, 13) of which at least 15% by weight is in the form of a sow of essentially cylindrical shape (11) with a height h and maximum diameter d;
loading said load into a cylindrical induction furnace (10) with a height H and maximum internal diameter D in which the height direction of said sow is substantially parallel to the height direction of the furnace;
melting said load by induction to obtain a liquid metal bath (2);
optionally adjusting the content of said liquid metal, wherein d is in the range from 0.7 D to 0.97 D and preferably in the range from 0.84 D to 0.92 D.

2. The method according to claim 1, wherein the diameter positioned at mid-height h/2 of the sow of essentially cylindrical shape is located at a distance from the bottom of the furnace between H/2−H/4 and H/2+H/4.

3. The method according to claim 1, wherein the sow of essentially cylindrical shape has an opening in its center (111).

4. The method according to claim 3, wherein the sow of essentially cylindrical shape is handled during the loading step by a handling tool (3) inserted through said opening (111).

5. A method for manufacturing an intermediate product (100, 101), such as a rolling plate, extrusion billet, forging block or ingot or sow, characterized in that it comprises:
obtaining a liquid metal bath optionally content adjusted by the melting method according to claim 1;
optionally filtering and/or treating said liquid metal (2);
forming said intermediate product (100, 101) by casting said liquid metal.

6. The method for manufacturing an intermediate product according to claim 5, wherein at least 60% of the load is derived from remelt metal.

7. An essentially cylindrical aluminum sow with a height h and a maximum diameter d suitable for melting.

8. The sow according to claim 7, provided with at least two legs (113).

9. The sow according to claim 7, wherein the sow of essentially cylindrical shape is truncated at the ends by at least one diameter (114).

10. A mold (4) for casting an aluminum sow of essentially cylindrical shape with a height h and a maximum diameter d.

11. The mold according to claim 10, comprising a recessed central tip (411) for making the opening (111).

12. The mold according to claim 11, wherein the central tip (411) for making the opening (111) is removable.
